(19) United States
(12) Patent Application Publication
(10) Pub. No.: US 2004/0254827 A1
(43) Pub. Date: Dec. 16, 2004

(54) Methods, systems and computer program products for indirect profiling of web users

(76) Inventors: John R. Hind, Raleigh, NC (US); Marcia L. Stockton, Bakersfield, CA (US)

Correspondence Address: MYERS BIGEL SIBLEY & SAJOVEC, PO BOX 37428, RALEIGH, NC, 27627, US

(21) Appl. No.: 10/460,929

(22) Filed: Jun. 13, 2003

(51) Int. Cl. G06F 17/60; G06F 15/16

(52) U.S. Cl. 705/10; 709/203

(57) ABSTRACT

Methods, systems and computer program products that indirectly profile users of a web service by providing a plurality of user customization options for the web service associated with corresponding user demographics so as to allow indirect user profiling based on a user's selection of at least one of the plurality of user customization options.

### FIELD OF THE INVENTION

The present invention relates to user activities on a network and, more particularly, to user profiling.

### BACKGROUND OF THE INVENTION

As electronic databases continue to replace conventional alternatives such as phone books, newspapers, shopping malls and the like, it is becoming increasingly difficult for those selling products and services to tailor advertisements and/or products to their customer base. For example, advertising in a phonebook is simple. If a user of a phonebook is looking for a phone number of a restaurant, the page(s) containing the restaurant phone numbers may contain numerous advertisements for restaurants. Similarly, people who read, for example, the Wall Street Journal may have similar characteristics. These characteristics may be used to tailor the advertisements provided in the Wall Street Journal to a specific reader base. Tailoring advertisements to a predictable user base may be more successful and cost effective. However, the unpredictability of a user's actions while surfing the web may not easily lend itself to tailoring advertisements and/or content to particular user characteristics.

Profiling of web users is well known to those having skill in the art. Conventional profiling techniques may include, for example, tracking the user's web surfing behaviour using cookies, tracking information provided by the user during a registration process, tracking a user's click stream data, and the like. User profiling is discussed, for example, in PCT Application No. PCT/U.S.99/28335 entitled Smart Agent Based on Habit, Statistical Inference and Psycho-Demographic Profiling, PCT Application No. PCT/EP00/10387 entitled Selective Supply of Media Objects By an Operator and U.S. Pat. No. 5,754,939 entitled System for Generation of User Profiles for a System for Customized Electronic Identification of Desireable Objects, the disclosures of which are hereby incorporated herein by reference.

A web portal, for example, My Yahoo®, may use profiling to present content that interests the user and/or to provide accurate demographic data for prospective advertisers that may help them match ad content with likely sales prospects. Accordingly, web portals, and recently other web providers such as news services, frequently request that the user fill out a profile form. The profile form may request, for example, the user's name, gender, age, address, income bracket, employment, recreational activities, hobbies, and the like. The data provided in the user profile may be used along with data mining, i.e. technique for selecting records from a database about many persons, based on specified characteristics of the persons, to learn more about the user and target the user for, for example, print, email and/or direct-mail advertising.

However, as people become more interested in privacy on the web, users of web portals and/or other websites may not be completely truthful when filling out the user profile or may even provide a completely false user profile. Accordingly, users may obtain the web content they request without divulging useful information for profiling the user. Using the partially or completely false profile to tailor the content of the information provided to the user and/or tailor advertisements to the user's interest may result in providing inappropriate information and/or advertisements. Furthermore, conventional profiling methods typically do not provide a validation mechanism to check the accuracy of the user-provided profile. Accordingly, the erroneous results obtained from the partially or completely false profiles typically cannot be corrected or assessed.

### SUMMARY OF THE INVENTION

Embodiments of the present invention provide methods, systems and computer program products for indirectly profiling users of a web service by providing a plurality of user customization options for the web service associated with corresponding user demographics so as to allow indirect user profiling based on a user's selection of at least one of the plurality of user customization options.

In some embodiments of the present invention, user input that selects at least one of the plurality of user customization options may be obtained and an indirect user profile may be generated based on the selected user customization options. In certain embodiments of the present invention, a user-provided profile may be obtained and the indirect user profile may be compared with the user-provided profile to provide a comparison result. A probability associated with a degree of similarity between the indirect user-profile and the user-provided profile may be assigned to the comparison result to provide a similarity score. In some embodiments of the present invention, the indirect user profile may be generated by assigning a probability to the user demographics associated with the selected user customization options.

In further embodiments of the present invention a second plurality of user customization options for the web service associated with corresponding user demographics may be provided based on the indirect user profile and/or the similarity score so as to allow the indirect user profile and/or the similarity score to be refined based on the user's selection of the second plurality of user customization options. In certain embodiments of the present invention, user input that selects at least one of the second plurality of user customization options may be obtained and the indirect user profile may be refined based on the selected at least one of the second plurality of user customization options. In some embodiments of the present invention, the user demographics may include gender, age, geographic location, education, profession and/or economic status.

In still further embodiments of the present invention, the user's web activity may be monitored to obtain click stream data and an indirect user profile and/or similarity score may be refined based on the obtained click stream data. In certain embodiments of the present invention, information provided in a cookie on a communications device accessed by the user may be obtained and the indirect user profile and/or the similarity score may be refined based on the information provided in the cookie. Furthermore, polling questions may be provided and the indirect user profile and/or similarity score may be further refined based on the user's answers provided in response to the polling questions.

In some embodiments of the present invention, the user customization options may be provided based on the user's geographic location. In certain embodiments the user customization options may include decorative visual elements and/or layouts of items on a display.

In further embodiments of the present invention, information may be requested to be transmitted to the user and content of requested information may be customized based on the indirect user profile and/or the similarity score. In certain embodiments of the present invention an advertisement to be included with the requested information may be selected based on the indirect user profile and/or the similarity score and the requested information may be transmitted including the selected advertisement.

As will further be appreciated by those of skill in the art, while described above primarily with reference to method aspects, the present invention may be embodied as methods, apparatus/systems and/or computer program products.

### BRIEF DESCRIPTION OF THE DRAWINGS

FIG. 1 is a block diagram of a data processing system suitable for use in embodiments of the present invention;

FIG. 2 is a more detailed block diagram of a system according to embodiments of the present invention;

FIG. 3 is a block diagram illustrating embodiments of the present invention illustrated in an exemplary network environment;

FIG. 4 is a flowchart illustrating operations according to some embodiments of the present invention;

FIG. 5 is a flowchart illustrating operations according to further embodiments of the present invention; and

FIG. 6 is a flowchart illustrating operations according to still further embodiments of the present invention.

### DETAILED DESCRIPTION OF THE INVENTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by those of skill in the art, the present invention may be embodied as methods, data processing systems, and/or computer program products. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions/acts specified in the flowchart and/or block diagram block or blocks.

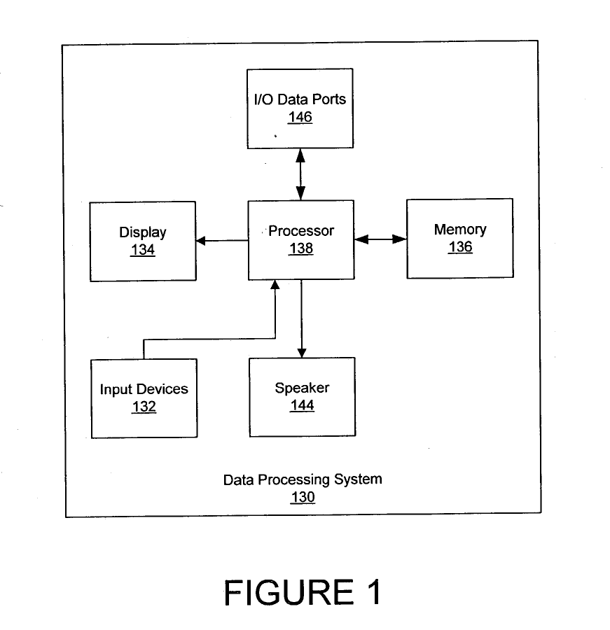

Various embodiments of the present invention will now be described with reference to FIGS. 1 through 6. Embodiments of the present invention provide methods, systems and computer program products that provide a plurality of user customization options of a web service associated with corresponding user demographics so as to allow indirect user profiling based on a user's selection of user customization options. The generated indirect user profile may be compared to a user-provided profile to assess the accuracy of the user-provided information. Accordingly, embodiments of the present invention may, for example, provide a validation mechanism to check the accuracy of the user-provided profile as discussed further herein.

Referring now to FIG. 1, an exemplary embodiment of a data processing system 130 suitable for use in accordance with embodiments of the present invention will be discussed. The data processing system 130 typically includes input device(s) 132 such as a keyboard or keypad, a display 134, and a memory 136 that communicate with a processor 138. The data processing system 130 may further include a speaker 144, and an I/O data port(s) 146 that also communicate with the processor 138. The I/O data ports 146 can be used to transfer information between the data processing system 130 and another computer system or a network. These components may be conventional components, such as those used in many conventional data processing systems, which may be configured to operate as described herein.

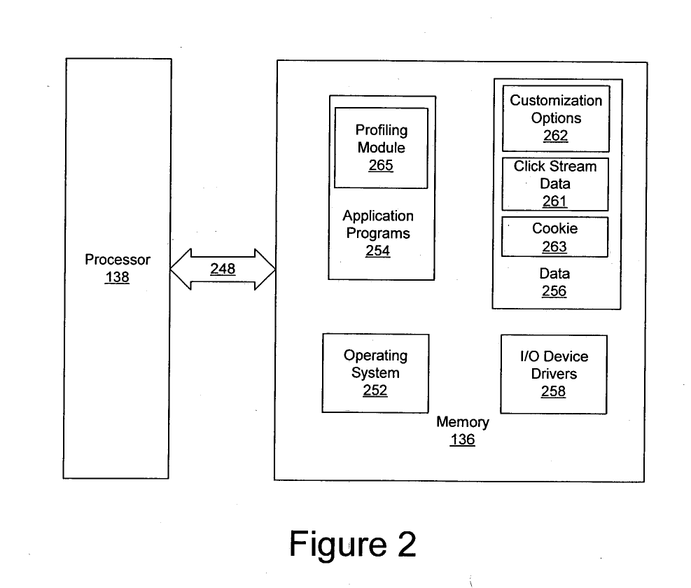

Referring now to FIG. 2, a block diagram of a data processing system that illustrates systems, methods, and computer program products in accordance with embodiments of the present invention will be discussed. The processor 138 communicates with the memory 136 via an address/data bus 248. The processor 138 can be any commercially available or custom microprocessor. The memory 136 is representative of the overall hierarchy of memory devices containing the software and data used to implement the functionality of the data processing system 130. The memory 136 can include, but is not limited to, the following types of devices: cache, ROM, PROM, EPROM, EEPROM, flash memory, SRAM, and DRAM.

As shown in FIG. 2, the memory 136 may include several categories of software and data used in the data processing system 130: an operating system 252; application programs 254; input/output (I/O) device drivers 258; and data 256. As will be appreciated by those of skill in the art, the operating system 252 may be any operating system suitable for use with a data processing system, such as OS/2, AIX or zOS from International Business Machines Corporation, Armonk, N.Y., Windows95, Windows98, Windows2000 or WindowsXP from Microsoft Corporation, Redmond, Wash., Unix or Linux. The I/O device drivers 258 typically include software routines accessed through the operating system 252 by the application programs 254 to communicate with devices such as the I/O data port(s) 146 and certain memory 136 components. The application programs 254 are illustrative of the programs that implement the various features of the data processing system 130 and preferably include at least one application that supports operations according to embodiments of the present invention. Finally, the data 256 represents the static and dynamic data used by the application programs 254, the operating system 252, the I/O device drivers 258, and other software programs that may reside in the memory 136.

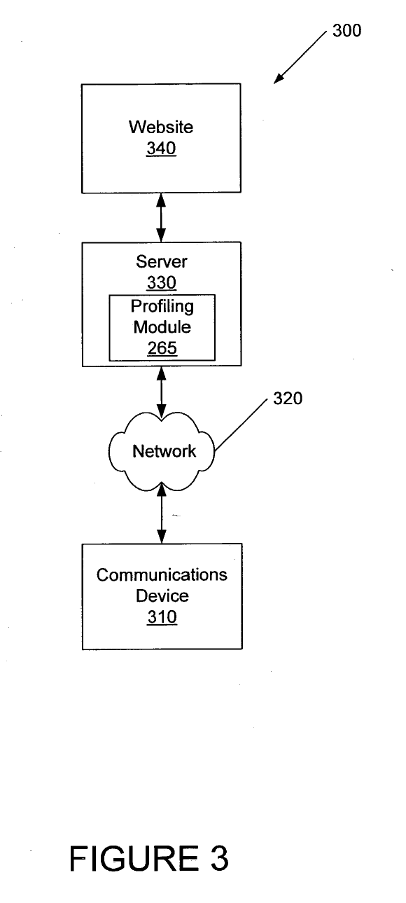

As further illustrated in FIG. 2, the application programs 254 may include a profiling module 265 according to embodiments of the present invention. The profiling module 265 may provide a plurality of user customization options associated with corresponding user demographics so as to allow indirect user profiling based on a user's selection of at least one of the plurality of user customization options. The data portion 256 of memory 136, as shown in the embodiments of FIG. 3, may include the plurality of customization options 262 provided by the profiling module 265 to the user to allow indirect user profiling as described herein. The data portion 256 of memory 136 may further include click stream data 261 and/or cookie(s) 263 that may be used to refine the user profile as also discussed herein.

While the present invention is illustrated, for example, with reference to the profiling module 265 being an application program in FIG. 2, as will be appreciated by those of skill in the art, other configurations may also be utilized while still benefiting from the teachings of the present invention. For example, the profiling module 265 may also be incorporated into the operating system 252 or other such logical division of the data processing system 130. Thus, the present invention should not be construed as limited to the configuration of FIG. 2 but is intended to encompass any configuration capable of carrying out the operations described herein.

Furthermore, while the profiling module 265 is illustrated in a single data processing system, as will be appreciated by those of skill in the art, such functionality may be distributed across one or more data processing systems. Thus, the present invention should not be construed as limited to the configuration illustrated in FIGS. 1 through 2 but may be provided by other arrangements and/or divisions of function between data processing systems.

It will be understood that the profiling module 265 according to embodiments of the present invention may be provided as part of web server software on a server in a network and/or as an application on a client device (communications device) that may be connected to the network. The web server software may be, for example, a web portal application, for example, My Yahoo®. It will be further understood that although the profiling module 265 is discussed herein as part of a web portal application running on a web server, embodiments of the present invention are not limited to this configuration. For example, the profiling module 265 according to embodiments of the present invention may be included in click stream data analysis software products and/or data mining software products to provide indirectly obtained demographic data about users without departing from the teachings of the present invention.

Referring now to FIG. 3, a block diagram of embodiments of the present invention implemented in an exemplary network environment will be described. As illustrated, the network environment 300 may include a communications device 310 (client device), a network 320, a server 330 and a website 340. The communications device 310 may be, for example, a laptop computer, a desktop computer, a personal data assistant (PDA), a web capable mobile terminal or any device capable of communicating with the network 320. The communications device 310 may communicate over the network 320, for example, the internet, through, for example, a telephone line, a digital subscriber link (DSL), a broadband cable link, a wireless link or the like. The server 330 may also communicate over the network 320. Thus, the network 320 may convey data between the communications device 310 and the server 330.

As illustrated, the server 330 may include the profiling module 265 according to some embodiments of the present invention. It will be understood that the server 330 may be an application server, web server or the like. It will be further understood that the network environment illustrated in FIG. 3 is provided for exemplary purposes only and that the invention is not limited to this configuration. For example, although the profiling 265 module is provided in the server 330 in FIG. 3, the profiling module 265 may be provided in, for example, the communications device 310. Furthermore, the website 340 may be integrated with the server 330. It will be further understood that the system illustrated in FIG. 3 may include one or more communications devices 310, networks 320, servers 330 and/or websites 340 without departing from the teachings of the present invention.

Exemplary operations of the present invention will now be discussed with respect to FIGS. 1 through 3. The communications device 310 may connect to the server 330 through the network 320. A user of the communications device 310 may customize an interface used to access information from different providers on the network 320, for example, the user may access information from the website 340. It will be understood that the website 340 can be any type of website, for example, a news website, a weather website, a shopping website and the like, without departing from the teachings of the present invention. The interface chosen by the user may be, for example, a web portal application, for example, My Yahoo®, running on the server 330. Typically, the user subscribes to a web portal application, at which point the user is given an opportunity to customize the interface. The profiling module 265 according to embodiments of the present invention may be integrated with the web portal application to provide a plurality of user customization options 262 stored in memory 136. It will be understood that embodiments of the present invention are not limited to being integrated with web portal applications, for example, embodiments of the present invention may integrated with click stream data analysis software and/or data mining software as discussed above without departing from the teachings of the present invention.

Accordingly, the user may customize the interface using user customization options 262 according to embodiments of the present invention. The user customization options 262 may include, for example, decorative visual elements, layouts of items on the display, and the like. As used herein “decorative visual elements” may include, for example, background colors, background images, fonts, headings, table rows, margins, navigation bars, icons and the like. It will be understood that decorative visual elements according to embodiments of the present invention may be combined to provide customized skins, i.e. a customized interfaces that provide a unique look. For example, the decorative visual elements may include a plurality of icon choices for various functionalities, for example, a logon icon, a weather icon, a home icon, a news icon, a help icon, and the like. The user may select a collection of icons including icons having one or more of these functionalities. The icons in the collection of icons may have a common theme, for example, sports, animals, plants and the like. Furthermore, customization options related to the layout of items on the display may include a user's preference for which types of information is placed at the top of the page versus the bottom of the page.

The user customization options 262 or combination of customization options, i.e. skins, provided by the profiling module 265 each have a corresponding demographic characteristic(s), for example, female, male, under the age of 13, over the age of 60 and the like, associated therewith. Generally, the demographic characteristics relate to, for example, gender, age, geographic location, education, profession and/or economic status.

For example, if the user chooses a pink background, the corresponding demographic characteristic may be that the user is female. Furthermore, the profiling module 265 may also associate a probability with the demographic data that represents the likelihood that this demographic characteristic is accurate. For example, if the user chooses a pink background color, there may be a ninety percent chance that the user is female. On the other hand, if the user chooses a script font, there may be a fifty one percent chance that the user is a female. It will be understood that in certain embodiments of the present invention a probability may be assigned to patterns of preferences (skin), for example, the combination of a pink background, script font and a graphic of a kitten may indicate a thirty four percent chance that the user is a female under the age of sixteen.

The correlation between the user customization options 262 and the demographic characteristics may be obtained through, for example, known accurate historical data, psychological testing, research of cultural norms and/or any method that may establish a correlation between a user's preference for certain customization options and specific demographic characteristics, the details of which are beyond the scope of this invention and will not be discussed further herein. It will be understood that different customization options may be provided to users based on the user's geographic location. For example, customization options that may indicate certain demographic characteristics for people from the United States might not necessarily indicate the same demographic characteristics for people from the Middle East. The probable geographic location of a particular user may be determined by, for example, the user's Internet protocol (IP) address.

Accordingly providing the plurality of user customization options 262 associated with corresponding user demographics as discussed above may allow an indirect user profile to be obtained based on the user customization options selected by the user. The indirect user profile as used herein may be a set of information about the user in terms of probabilities. Thus, as discussed above, the indirect user profile may be a list of demographic characteristics that have associated probabilities.

In certain embodiments of the present invention, a direct user profile may be obtained. For example, the user may be asked to provide personal data before the user is granted access to certain information on the web. For example, if the user wants to read the news provided on the Wall Street Journal's website, the user may have to provide his/her name, address, phone number, type of employment, email address and the like. Once this information is provided, the Wall Street Journal website may place a cookie on the communications device 310 accessed by the user. A cookie 263 is a small piece of information that is placed on the communications device 310 by a website 340 that is used to store information so that a website can identify the user/communications device 310 between visits. Thus, for example, after the user profile information is entered, the website may assign the communications device 310 a unique number and store it in a cookie on the communications device 310. The next time the user visits the website, the website can read the cookie and automatically know the details provided in the user profile. Often, a user will not be completely honest when providing this information in the interest of maintaining privacy or avoiding receiving information on the phone, through the mail or via email.

Once the indirect user profile is obtained based on the user's selected user customization options 262, the indirect user profile may be compared with user-provided profile data to provide a comparison result. A probability may be assigned to the comparison result that may indicate a degree of similarity between the indirect user profile and the user-provided profile and may be used to assess the accuracy of the information provided by the user. The probability associated with a degree of similarity and/or dissimilarity between the indirect profile and the user-provided profile may be termed a similarity score. The similarity score may be calculated using standard probabilities, the details of which are beyond the scope of this invention and will not be discussed further herein. The higher the degree of correlation between the indirect user profile and the user-provided profile indicated by the similarity score, the more likely the user-provided profile is accurate. Similarly, the lower the degree of correlation (anti-correlation) between the indirect user profile and the user-provided profile indicated by the similarity score, the more likely the user-provided profile is inaccurate. The similarity score may include the information provided by the user in the user-provided profile and corresponding probabilities indicating the likelihood that the associated information is true, false or both. For example, the similarity score may include the following information provided by the user and corresponding probabilities: Gender=Female: True=60%, False: 40%; Age=25: True=40%, False=60%; Geographic Location=New York: True=50%, False=50% and Economic Status=greater than 100,000 dollars/year: True=20%, False=80%.

Once an initial indirect profile and similarity score are obtained, the initial indirect profile and similarity score may be refined to obtain a more accurate profile of the user. For example, a second set of user customization options 262 stored in memory 136 may be provided by the profiling module 265. The second set of user customization options 262 may be highly determinative customization options, for example, each of the customization options 262 may indicate a very high probability that the user matches the associated demographic characteristic(s). For example, the second set of customization data may only include customization options that provide a ninety percent or higher chance of complying with the associated demographic characteristic. For example, if the user initially chose a script font, which indicated there was a fifty one percent chance that the user is female, the profiling module 265 may provide a customization option in the second set of customization options that includes floral accents for the script font, for example, flowers for periods and exclamation points. If a user chooses this customization option, there may be a ninety five percent chance that the user is female. The selection of customization options from the second set of customization options may further refine the initial indirect profile and may increase the likelihood that the user is female. This information may also be used to refine the similarity score. Thus, the profiling module 265 may recompute the probabilities of the indirect user profile and/or the similarity score based on newly obtained information.

As discussed above, a user may intentionally provide incorrect information responsive to a request for personal information by a provider. Accordingly, it is also possible that a user may select customization options to invalidate indirect user profiling according to embodiments of the present invention. Thus, the present invention provides methods of refining the initial indirect profile and/or the similarity score based on the user's web activity. For example, a user's click stream data 261 may be monitored. In other words, the websites, for example, website 340, that the user visits and the information accessed by the user from these websites may be monitored. The click stream data may be monitored, for example, by a web advertising broker, for example, Double Click®, or may be monitored directly by the profiling module 265. This information may be used to refine, i e. validate and/or invalidate, the indirect user profile and/or the user-provided profile. For example, if the indirect user profile and the user-provided profile both indicate that user is a female living in the Midwest, but the click stream data reveals daily activity on sports websites accessing scores for east coast teams, this may reduce the likelihood that the indirect profile and/or user-provided profile are accurate. Information in cookies 263 stored on the communications device 310 by, for example, website 340, may also be used to refine the initial indirect profile and/or similarity score according to some embodiments of the present invention.

Furthermore, the initial indirect profile and the similarity score may be refined using the user's answers to a plurality of polling questions. Polling questions are designed to produce accurate repeatable results. Thus, answers to polling questions are typically tested extensively to provide very accurate results. These types of questions may be used to validate and/or invalidate the indirect user profiles according to embodiments of the present invention. Techniques of using polling questions to validate and weigh samples are discussed in at World Wide Web address trochim.human.comell.edu/kb/contents.htm.

Indirect user profiles according to embodiments of the present invention may be provided to website providers so that the content of their websites may be tailored to their user base. Furthermore, the indirect user profiles according to embodiments of the present invention may also be provided to advertisers so that advertisements sent to a user during a web session may be tailored to a user's interests.

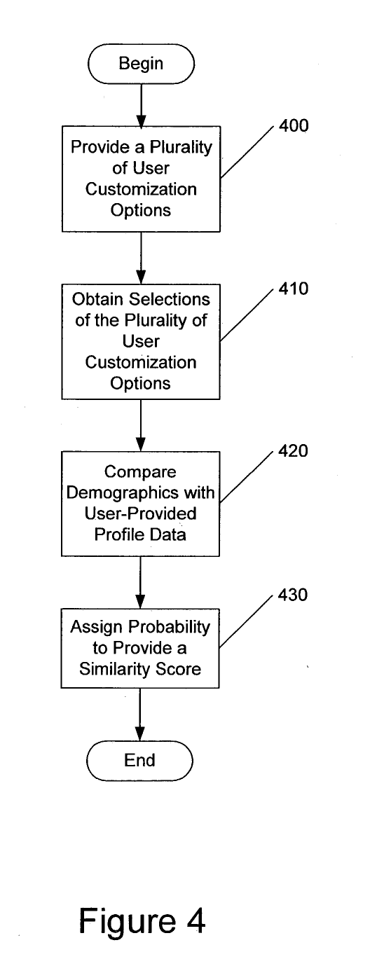

It will be understood that the example discussed above with respect to FIGS. 1 through 3 is not intended to limit embodiments of the present invention and is provided for exemplary purposes only. Operations according to embodiments of the present invention may include additional steps or omit steps discussed above without departing from the teachings of the present invention. Furthermore, the steps may be combined or performed in a different order than discussed above. Operations of a profiling module according to embodiments of the present invention will now be discussed further with respect to the flowcharts of FIGS. 4 through 6.

Referring now to FIG. 4, operations begin at block 400 by providing a plurality of user customization options. As discussed above, user customization options according to embodiments of the present invention may include one or more decorative visual elements as discussed above. User customization options or patterns of customization options, i.e., skins, have corresponding demographic characteristics. Different user customization options may be provided to users based on, for example, their geographic location, as discussed above. Selections of the plurality of user customization options may be obtained (block 410) and the selected user customization options may be used to provide an indirect user profile. For example, an indirect user profile may include the following probabilities: Gender=Female=51%, Age=under 16=70%, Geographic location=West Coast=75% and Economic Status=greater than 150,000 dollars per year=90%. The indirect user profile including one or more probabilities may be compared to a user-provided profile to provide a comparison result (block 420). A probability associated with a degree of similarity between the selected plurality of user customization options (indirect user profile) and the user-provided profile may be assigned to the comparison result to provide a similarity score (block 430). The probability assigned may be represented in terms of true and false probabilities based on the user-provided data. In other words, the probabilities may represent the likelihood that the user-provided accurate information in certain categories, the probability that a user-provided inaccurate information in certain categories and/or both. For example, a similarity score may include the following demographic characteristics and corresponding probabilities. Gender=Female: True=60%, False: 40%; Age=50: True=40%, False=60%; Geographic Location=California: True=50%, False=50% and Economic Status=less than 50,000 per year: True=20%, False 32 80%.

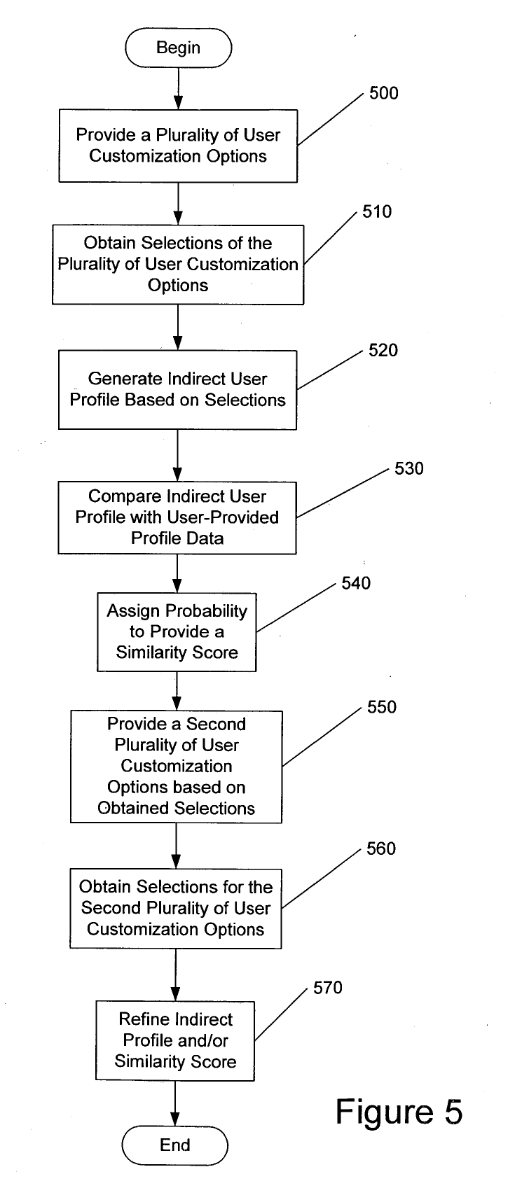

Referring now to FIG. 5, operations begin at block 500 by providing a plurality of user customization options. Selections of the plurality of the user customization options may be obtained (block 510) and the selected user customization options may be used to generate an indirect user profile (block 520). The indirect user profile including one or more probabilities may be compared to a user-provided profile (block 530) to provide a comparison result. A probability associated with a degree of similarity between the selected plurality of user customization options (indirect user profile) and the user-provided profile may be assigned to the comparison result to provide a similarity score (block 540). A second plurality of user customization options may be provided to refine the indirect user profile and/or the similarity score (block 550). As discussed above, the second set of user customization options may be highly determinative customization options, for example, each of the customization options may indicate a very high probability that the user matches the associated demographic characteristic. For example, the second set of customization data may only include customization options that provide a ninety percent or higher chance of complying with the associated demographic characteristic. Selections of the second plurality of user customization options may be obtained (block 560). The similarity score and/or indirect user profile may be refined based on the selected user customization options from the second set of user customization options (block 570).

It will be understood that the indirect user profile and/or similarity score may be further refined based on a user's web activity, for example, click stream data, cookies stored on a communications device and/or a user's answers to polling questions as discussed above.

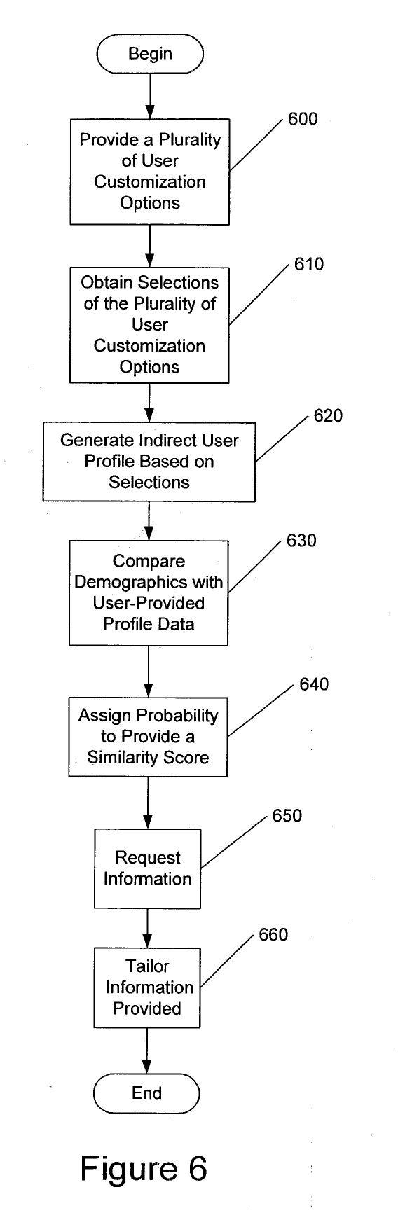

Referring now to FIG. 6, operations begin at block 600 by providing a plurality of user customization options. Selections of the plurality of the user customization options may be obtained (block 610) and the selected user customization options may be used to generate an indirect user profile (block 620). The indirect user profile including one or more probabilities may be compared to a user-provided profile (block 630) to provide a comparison result. A probability associated with a degree of similarity between the selected plurality of user customization options (indirect user profile) and the user-provided profile may be assigned to the comparison result to provide a similarity score (block 640). A user may request information from a website (block 650). The website may obtain the indirect user profile information according to embodiments of the present invention from, for example, the web portal being used by the user. The website provider may use this information to tailor the content of the website to be compatible with the greatest number of user's who access the website (block 660). Furthermore, an advertising server may use the indirect user profile information provided according to embodiments of the present invention to select an advertisement to be included with the requested information. Accordingly, the requested information may be transmitted with the advertisement selected for the particular user.

As discussed briefly above with respect to FIGS. 1 through 6, embodiments of the present invention provide methods, systems and computer program products that provide a plurality of user customization options associated with corresponding user demographics so as to allow indirect user profiling based on a user's selection of at least one of the plurality of user customization options. The present invention may be included in web portal applications, click stream data analysis software, data mining software and the like to assess the accuracy of user-provided profiles. Accordingly, content of websites and advertisements may be tailored to a user's demographic data more accurately.

The flowcharts and block diagrams of FIGS. 1 through 6 illustrate the architecture, functionality, and operation of possible implementations of systems, methods and computer program products according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed is:

1. A method for indirectly profiling users of a web service, comprising:
providing a plurality of user customization options for the web service associated with corresponding user demographics so as to allow indirect user profiling based on a user's selection of at least one of the plurality of user customization options.

2. The method of claim 1, further comprising:
obtaining user input that selects at least one of the plurality of user customization options; and
generating an indirect user profile based on the selected at least one of the plurality of user customization options.

3. The method of claim 2, further comprising:
obtaining a user-provided profile;
comparing the indirect user profile with the user-provided profile to provide a comparison result; and
assigning a probability associated with a degree of similarity between the indirect user-profile and the user-provided profile to the comparison result to provide a similarity score.

4. The method of claim 2, wherein generating the indirect user profile comprises assigning a probability to ones of the user demographics associated with the selected at least one of the plurality of user customization options.

5. The method of claim 3, further comprising:
providing a second plurality of user customization options for the web service associated with corresponding user demographics based on the indirect user profile and/or the similarity score so as to allow the indirect user profile and/or the similarity score to be refined based on the user's selection of at least one of the second plurality of user customization options.

6. The method of claim 5, further comprising:
obtaining user input that selects at least one of the second plurality of user customization options; and
refining the indirect user profile based on the selected at least one of the second plurality of user customization options.

7. The method of claim 5, wherein the user demographics comprise gender, age, geographic location, education, profession and/or economic status.

8. The method of claim 3, further comprising:
monitoring the user's web activity to obtain click stream data; and
refining the indirect user profile and/or similarity score based on the obtained click stream data.

9. The method of claim 3, further comprising:
obtaining information provided in a cookie on a communications device accessed by the user; and
refining the indirect user profile and/or the similarity score based on the information provided in the cookie.

10. The method of claim 3, further comprising:
providing a plurality of polling questions; and
refining the indirect user profile and/or similarity score based on the user's answers provided in response to at least one of the polling questions.

11. The method of claim 1, wherein providing the plurality of user customization options comprises providing the plurality of user customization options based on the user's geographic location.

12. The method of claim 1, wherein the plurality of user customization options comprises a plurality of decorative visual elements and/or layouts of items on a display.

13. The method of claim 3, further comprising:
requesting information to be transmitted to the user; and
customizing content of requested information based on the indirect user profile and/or the similarity score.

14. The method of claim 13, further comprising:
selecting at least one advertisement to be included with the requested information based on the indirect user profile and/or the similarity score; and
transmitting the requested information including the selected at least one advertisement to the user.

15. A system for indirectly profiling users of a web service, comprising:
a profiling module that provides a plurality of user customization options for the web service associated with corresponding user demographics so as to allow indirect user profiling based on a user's selection of at least one of the plurality of user customization options.

16. The system of claim 15, wherein the profiling module is further configured:
to obtain user input that selects at least one of the plurality of user customization options; and
generate an indirect user profile based on the selected at least one of the plurality of user customization options.

17. The system of claim 16 wherein the profiling module is further configured to:
obtain a user-provided profile;
compare the indirect user profile with the user-provided profile to provide a comparison result; and
assign a probability associated with a degree of similarity between the indirect user-profile and the user-provided profile to the comparison result to provide a similarity score.

18. The system of claim 16, wherein the profiling module is further configured to assign a probability to ones of the user demographics associated with the selected at least one of the plurality of user customization options.

19. The system of claim 17, wherein the profiling module is further configured to:
provide a second plurality of user customization options for the web service associated with corresponding user demographics based on the indirect user profile and/or the similarity score so as to allow the indirect user profile and/or similarity score to be refined based on the user's selection of at least one of the second plurality of user customization options.

20. The system of claim 19, wherein the profiling module is further configured to:
obtain user input that selects at least one of the second plurality of user customization options; and
refine the indirect user profile based on the selected at least one of the second plurality of user customization options.

21. The system of claim 15, wherein the user demographics comprise gender, age, geographic location, education, profession and/or economic status.

22. The system of claim 17, wherein the profiling module is further configured to:
monitor the user's web activity to obtain click stream data; and
refine indirect user profile and/or similarity score based on the obtained click stream data.

23. The system of claim 17, wherein the profiling module is further configured to:
obtain information provided in a cookie on a communications device accessed by the user; and
refine the indirect user profile and/or the similarity score based on the information provided in the cookie.

24. The system of claim 17, wherein the profiling module is further configured to:
provide a plurality of polling questions; and
refine the indirect user profile and/or similarity score based on the user's answers provided in response to at least one of the polling questions.

25. The system of claim 15, wherein the profiling module is further configured to provide the plurality of user customization options based on the user's geographic location.

26. The system of claim 15, wherein the plurality of user customization options comprises a plurality of decorative visual elements and/or layouts of items on a display.

27. The system of claim 17, wherein the profiling module is integrated in a web portal application, click stream data analysis software and/or data mining software.

28. The system of claim 27, wherein the profiling module is integrated in the web portal application and the web portal application is located on a server in a network.

29. A system for indirectly profiling users of a web service, comprising:
means for providing a plurality of user customization options for the web service associated with corresponding user demographics so as to allow indirect user profiling based on a user's selection of at least one of the plurality of user customization options.
means for obtaining user input that selects at least one of the plurality of user customization options; and
means for generating an indirect user profile based on the user's selection of the at least one of the plurality of user customization options.

30. A computer program product for indirectly profiling users of a web service, comprising:
a computer readable medium having computer readable program code embodied therein, the computer readable program product comprising:
computer readable program code configured to provide a plurality of user customization options for the web service associated with corresponding user demographics so as to allow indirect user profiling based on a user's selection of at least one of the plurality of user customization options.
